(19) United States
(12) Patent Application Publication
(10) Pub. No.: US 2015/0026097 A1
(43) Pub. Date: Jan. 22, 2015

(54) SYSTEM AND METHOD FOR COMPLIANCE MONITORING AND RESOLUTION OF BROKERAGE ACCOUNT MAINTENANCE REQUIREMENTS

(71) Applicant: Plastiq Inc., Boston, MA (US)

(72) Inventor: Michail Medvinsky, Wellseley, MA (US)

(21) Appl. No.: 14/312,367

(22) Filed: Jun. 23, 2014

Related U.S. Application Data
(60) Provisional application No. 61/856,419, filed on Jul. 19, 2013.

(51) Int. Cl. G06Q 20/40

(52) U.S. Cl. CPC G06Q 20/403; G06Q 40/06; G06Q 40/02
USPC 705/36 R

(57) ABSTRACT

A system and method for automatically monitoring brokerage accounts and preemptively, via credit card authorization, transferring funds to said brokerage accounts to avoid non-compliance of maintenance requirements. As brokerage accounts recover and rise above maintenance requirements, funds authorized from credit cards may automatically be refunded.

### CROSS-REFERENCE TO RELATED APPLICATIONS

The present application claims the benefit of U.S. Provisional Patent Application No. 61/856,419, filed Jul. 19, 2013, the disclosure of which is hereby incorporated by reference herein in its entirety.

### TECHNICAL FIELD

Embodiments of the invention relate generally to brokerage account maintenance requirements and, more specifically, to a system and method for enabling an automated compliance monitoring and resolution mechanism to service brokerage account maintenance requirements.

### BACKGROUND

Maintenance (margin) requirements is a form of financial compliance used by brokerage firms to keep their books properly leveraged and their businesses solvent, especially in the domains of consumer driven equity and options trading. Typically, when a maintenance event or a margin call is encountered, a brokerage account holder has a short period of time, or sometimes no time at all, to draw on additional funds to bring their account back into compliance with maintenance requirements. When a brokerage account holder is unable to draw on additional funds in a timely fashion, brokerages may sell securities held in the brokerage account to satisfy maintenance requirements.

To avoid a maintenance event or a margin call, brokerage account holders must proactively monitor and allocate funds into their brokerage accounts. Known drawbacks with this approach include, but are not limited to, the availability of funds when needed and the ability to transfer those funds quickly to satisfy maintenance requirements.

Accordingly, there is a desire to provide an automated compliance monitoring and resolution mechanism to service brokerage account maintenance requirements.

### BRIEF DESCRIPTION OF THE DRAWINGS

The present invention is illustrated by way of example, and not by way of limitation, and will become apparent upon consideration of the following detailed description, taken in conjunction with the accompanying drawings, in which like reference characters refer to like parts throughout, and in which:

FIG. 1 is a block diagram illustrating an exemplary computer network in which embodiments of the present invention may operate.

FIG. 2 is a block diagram illustrating exemplary processing modules and components embodied in computer network elements of FIG. 1.

FIG. 3 is a flow diagram illustrating a method for managing compliance with brokerage account maintenance requirements in accordance with an embodiment of the invention.

FIG. 4 is a flow diagram illustrating a method for performing a risk calculation in accordance with an embodiment of the invention.

FIG. 5 illustrates a diagrammatic representation of a machine in the exemplary form of a computer system configured to perform one or more of the operations described herein.

### DETAILED DESCRIPTION

In the following description, numerous details are set forth. It will be apparent, however, to one skilled in the art, that the present invention may be practiced without these specific details. In some instances, well-known structures and devices are shown in block diagram form, rather than in detail, in order to avoid obscuring the present invention.

Some portions of the detailed descriptions may be presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, as apparent from the description that follows, it is appreciated that throughout the description, discussions utilizing terms such as “receiving”, “establishing”, “monitoring”, “determining”, “requesting”, “transmitting”, “identifying”, “issuing”, “transferring”, “calculating”, or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to an apparatus for performing the operations herein. This apparatus may be specially constructed for the required purposes or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs and magnetic-optical disks, read-only memories (ROMs), random access memories (RAMs), EPROMs, EEPROMs, magnetic or optical cards, flash memory devices including universal serial bus (USB) storage devices (e.g., USB key devices) or any type of media suitable for storing electronic instructions, each of which may be coupled to a computer system bus.

The algorithms and displays presented herein are not inherently related to any particular computer or other apparatus. Various general purpose systems may be used with programs in accordance with the teachings herein or it may prove convenient to construct more specialized apparatus to perform the required method steps. The required structure for a variety of these systems will be apparent from the description that follows. In addition, the present invention is not described with reference to any particular programming language. It will be appreciated that a variety of programming languages may be used to implement the teachings of the invention as described herein.

The present invention may be provided as a computer program product, or software, that may include a machine-readable medium having stored thereon instructions, which may be used to program a computer system (or other electronic devices) to perform a process according to the present invention. A machine-readable medium includes any mechanism for storing or transmitting information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices, etc.), a machine (e.g., computer) readable transmission medium (non-propagating electrical, optical, or acoustical signals), etc.

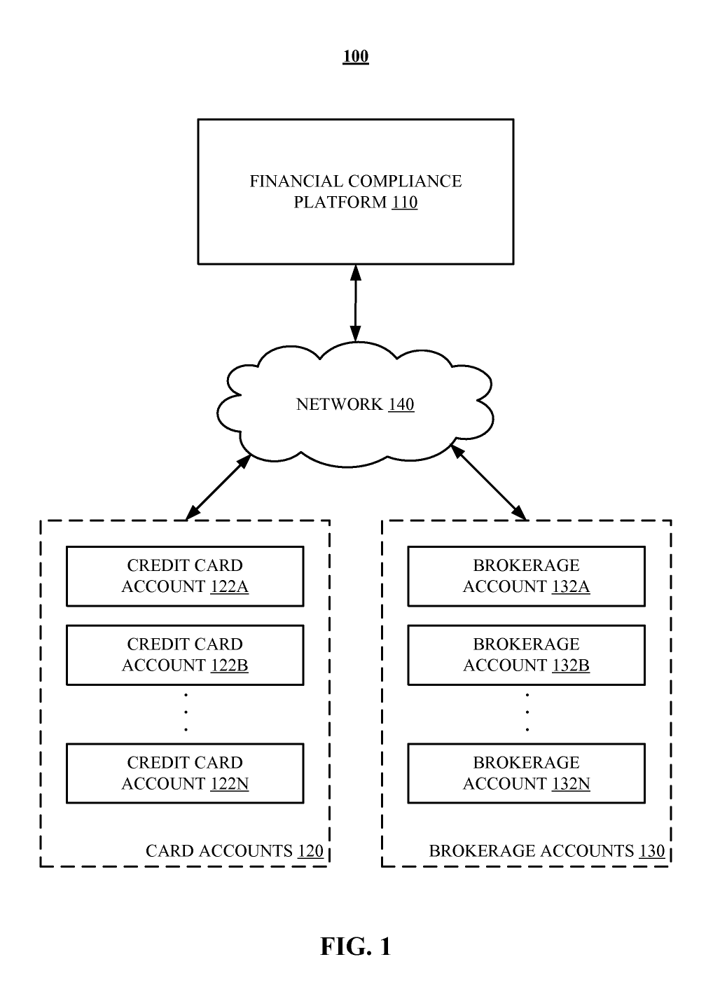

FIG. 1 is a block diagram illustrating an exemplary computer network 100 in which embodiments of the present invention may operate. Referring to FIG. 1, computer network 100 may be comprised of a computer-enabled financial compliance platform 110, a plurality of credit card accounts 120A-120N, collectively referred to herein as card accounts 120, and a plurality of brokerage accounts 130A-130N, collectively referred to herein as brokerage accounts 130. Financial compliance platform 110, card accounts 120 and brokerage accounts 130 may be communicatively coupled directly or via a communication network 140. Communication network 140 may be a private network (e.g., a local area network (LAN), wide area network (WAN), intranet, etc.), a public network (e.g., the Internet), a cellular network or any combination thereof.

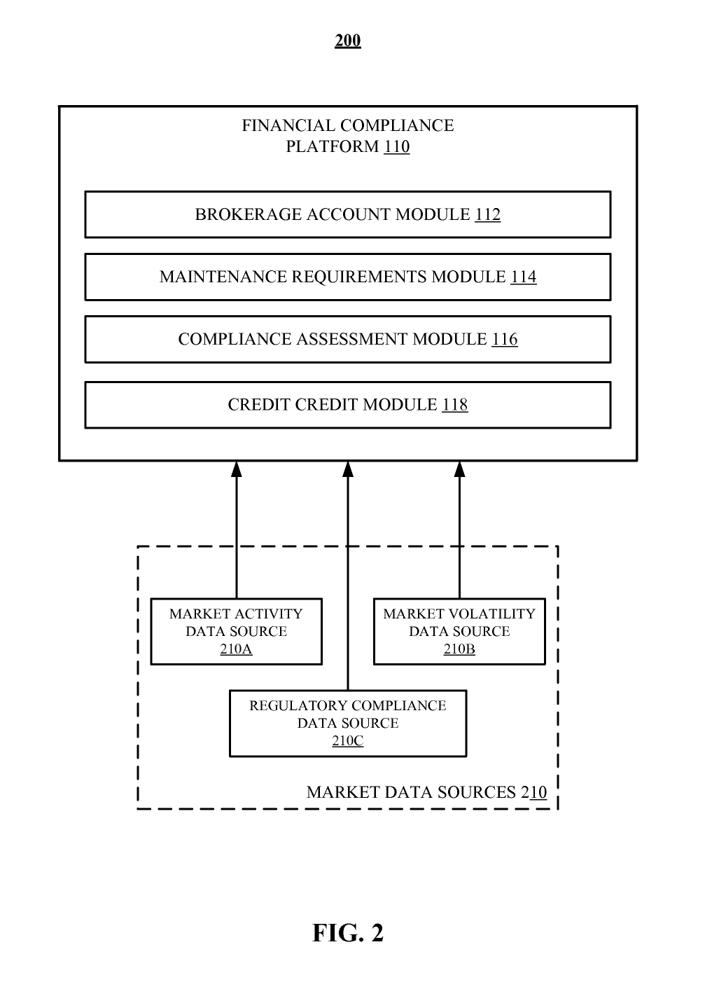

Financial compliance platform 110 may be comprised of one or more modules configured to monitor brokerage accounts and execute measures for maintaining compliance with brokerage account maintenance requirements. For example, as illustrated in FIG. 2, financial compliance platform 110 may be comprised of a brokerage account module 112, a maintenance requirements module 114, a compliance assessment module 116, and a credit card module 118. Brokerage account module 112 may be configured to manage all aspects of retrieving data from and transmitting data to brokerage accounts. Maintenance requirements module 114 may be configured to manage all aspects of retrieving and establishing maintenance requirements, as well as corresponding related data, for brokerage accounts. Compliance assessment module 116 may be configured to manage all aspects of monitoring compliance with maintenance requirements and assessing corresponding risk of non-compliance. Credit card module 118 may be configured to manage all aspects of authorizing funds to satisfy compliance with brokerage account maintenance requirements.

Financial compliance platform 110 may receive market-related data from one or more sources. In one embodiment, market-related data may be received directly from brokerage accounts. In another embodiment, market-related data may be received from one or more external market data sources. For example, market-related data may be received from a market activity data source 210A, a market volatility data source 210B and a regulatory compliance data source 210C, collectively referred to herein as market data sources 210. Market activity data source 210A may provide data relating to daily movements in the one or more markets. Market volatility data source 210B may provide data relating to volatility measurements in one or more markets. Regulatory compliance data source 210C may provide data relating legal regulatory requirements having an impact on brokerage account maintenance requirements. In yet another embodiment, market-related data may be received from a combination of brokerage accounts and external market data sources.

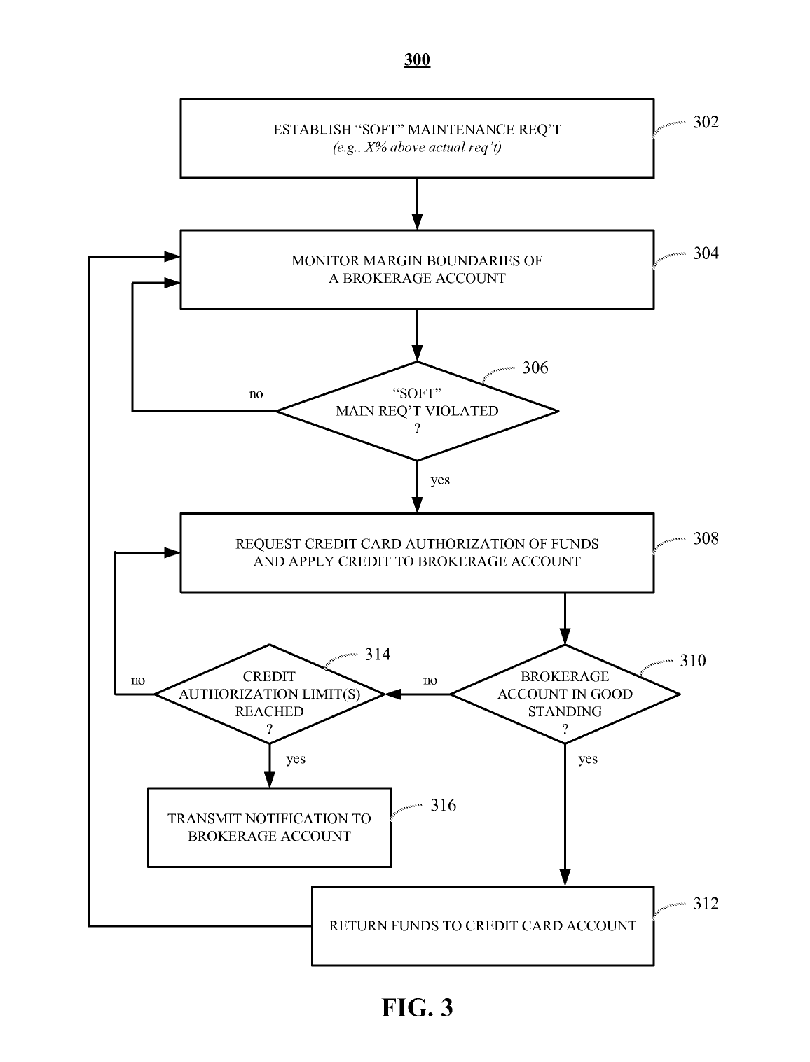

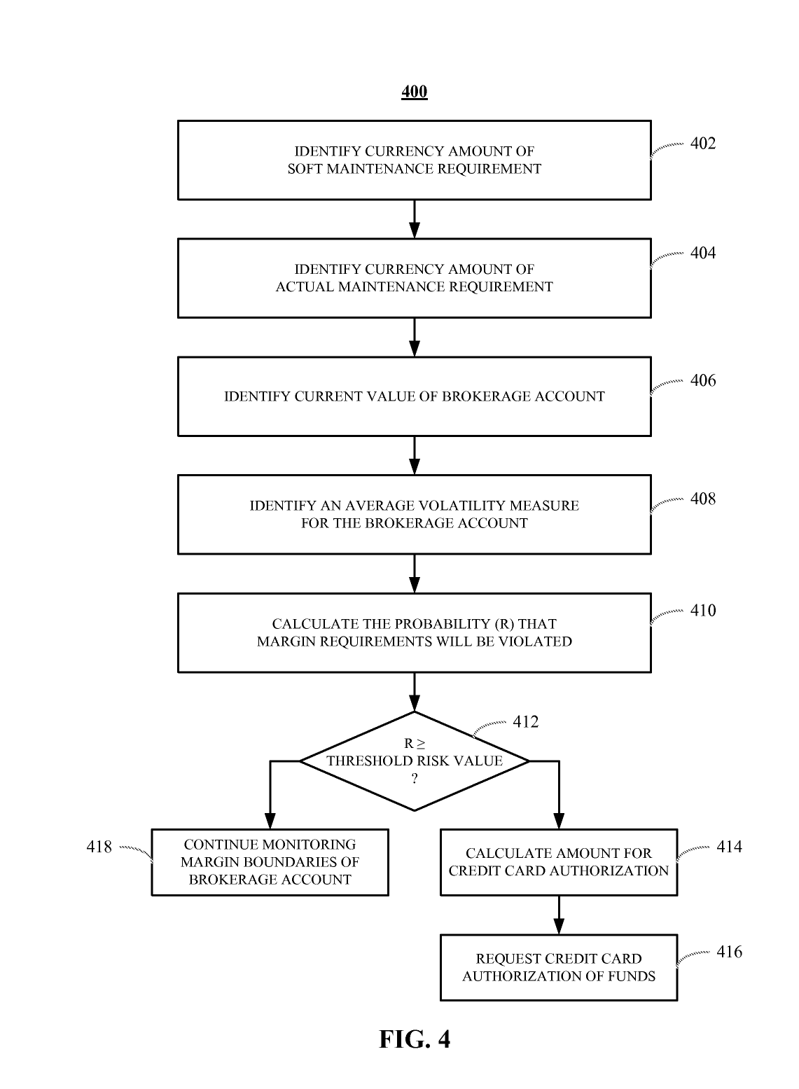

While modules of financial compliance platform 110 are shown as being co-located on a single platform, those skilled in the art will appreciate that one or more of the foregoing modules may be located elsewhere and communicatively coupled with financial compliance platform 110, and that financial compliance platform 110 is not limited to the modules shown, which are provided merely for purposes of illustrating an exemplary embodiment of the invention. Those skilled in the art will appreciate that financial compliance platform 110 may be configured with more or less modules to conduct the methods described herein with reference to FIG. 3 and FIG. 4.

As illustrated in FIG. 3 and FIG. 4, each of corresponding methods 300 and 400 may be performed by processing logic comprising hardware (e.g., circuitry, dedicated logic, programmable logic, microcode, etc.), software (such as instructions run on a processing device), or a combination thereof. In one embodiment, methods 300 and 400 may be performed by one or more processing components associated, respectively, with modules 112, 114, 116 and 118 of financial compliance platform 110.

FIG. 3 is a flow diagram illustrating a method 300 for managing compliance with brokerage account maintenance requirements, according to an embodiment of the invention. Referring to FIG. 3, method 300 may be initiated upon establishing, at step 302, a soft maintenance requirement for a brokerage account. The soft maintenance requirement may be a threshold maintenance requirement set above an actual maintenance requirement associated with the brokerage account. In one embodiment, the soft maintenance requirement may be a percentage of a brokerage account holder's portfolio added to the actual maintenance requirement of the brokerage account. In another embodiment, the soft maintenance requirement may just be a predetermined percentage amount higher than the actual maintenance requirement of the brokerage account. By utilizing a soft maintenance requirement, financial compliance platform 110 may be enabled to perform a risk calculation and take pre-emptive measures to avoid non-compliance of the actual maintenance requirement.

When a soft maintenance requirement is established, margin boundaries may be monitored, at step 304, to determine, at step 306, whether the brokerage account is in violation of the soft maintenance requirement. In one embodiment, market activity may be monitored in real-time against brokerage account values at the end of each trading day. As margin requirements are calculated and asserted after the market close, remaining assets in a brokerage account may be measured against the predefined thresholds associated with maintenance requirements.

If the brokerage account is deemed to have violated the threshold monetary value associated with the soft maintenance requirement, then a credit card authorization of funds may be requested and applied, at step 308, to the brokerage account. By permitting funds to be drawn from the credit card account, the brokerage account holder may avoid an imminent margin call without committing additional funds, or at least provide the brokerage account holder time to transfer additional funding into the brokerage account if a margin call is unavoidable, by temporarily making available funds that may be drawn from the brokerage account holder's credit card account. In a preferred embodiment, credit card funds made available to satisfy maintenance requirements are not made available to the brokerage account holder in the form of additional buying power.

After applying the requested credit to the brokerage account, a subsequent determination may be made, at step 310, to verify the brokerage account remains in good standing. As the brokerage account recovers and rises above maintenance requirements (e.g., due to account values changing, added funds, equity transfers, etc.), funds authorized from the brokerage account holder's credit card may be refunded, at step 312, automatically. However, if the brokerage account again falls below maintenance requirements after the requested credit is applied (e.g., due to sudden changes in the market, unfavorable transactions executed by the brokerage account holder, etc.), then an additional credit card authorization of funds may be requested, which may be subject to a further determination, at step 314, confirming credit card authorization limits have not been reached. For example, there may be a limit on the amount of available credit. When limits have been reached and further requests for credit card authorization are not available, a notification may be transmitted, at step 316, informing the brokerage account holder of the unavailability of credit card funds.

In order to ascertain whether credit card authorization of funds is required and, if so, the monetary amount of funds to be requested, a risk value corresponding to the probability that maintenance requirements will be violated may be calculated. The risk value may be calculated when, for example, a brokerage account is determined to be non-compliant with a soft maintenance requirement. In one embodiment, a risk value may be calculated as a probability that a brokerage account maintenance (margin) requirement could be violated during the next market session and may be represented as follows:

$$R = 1 - \frac{V ( 1 + X ) - M}{W - M} ,$$

where R is the probability that a maintenance requirement will be violated the next business day, W is the soft maintenance requirement, V is the current account value (including previously injected credit funds), M is the actual maintenance requirement, and X is a volatility measure. The volatility measure may be an average volatility measure of the last N days, where X<0 may suggest a downward trend in volatility, X=0 may suggest no volatility, and X>0 may suggest an upward trend in volatility. It should be noted that determination of a risk value is not limited to the foregoing calculation and those skilled in the art will appreciate that any number of algorithms may be employed to assess risk in accordance with embodiments of the invention.

FIG. 4 is a flow diagram illustrating a method 400 for performing a risk calculation, according to an embodiment of the invention. Referring to FIG. 4, the currency amount (W) representative of the soft maintenance requirement, the currency amount (M) representative of the actual maintenance requirement, the currency amount (V) representative of the current value of the brokerage account, and an average volatility measure (X) for the brokerage account may be identified, respectively, at steps 402-408, in order to calculate, at step 410, the probability (R) that a maintenance requirement will be violated by the brokerage account. One or more of the foregoing values identified, at steps 402-408, may be determined by the brokerage account and made available to financial compliance platform 110, determined by financial compliance platform 110 based on information received from the brokerage account, retrieved from external market data sources or any combination thereof.

Once a risk value, representative of the probability that a maintenance requirement will be violated, is calculated, a determination may be made, at step 412, to ascertain whether the risk value yielded is equal to or exceeds a predefined threshold risk value. Where R is greater than or equal to the threshold risk value, credit card authorization for funds may be requested. If R is determined to be greater than or equal to the threshold risk value, the amount of funds to be requested may be calculated, at step 414, and a corresponding credit card authorization of the calculated funds may be requested, at step 416. In one embodiment, calculating the amount of funds to be requested may be represented as follows:

R(W−V)

However, if R is determined to be less than the threshold risk value, then no request for credit card authorization of funds may be made and margin boundaries of the brokerage account may continue to be monitored, at step 418.

The following example is provided for purposes of illustrating the calculation of a risk value, representative of the probability that a maintenance requirement will be violated, and the calculation of a corresponding amount of funds to be requested in a credit card authorization. Take a brokerage account having a portfolio value of $10,000 with an actual maintenance requirement (M) of $7,000.00, a current value (V) of $7,500.00, a soft maintenance requirement (W) of $9,000 (20% of portfolio value+actual maintenance requirement), a reported negative volatility of −0.06, and a threshold risk value of 0.4. Applying the foregoing equation for calculating the probability (R) that the actual maintenance requirement will be violated, the following value of R is:

$$R = 1 - \frac{7500 ( 1 - .06 ) - 7000}{9000 - 7000} = 0.975$$

Since R is greater than the threshold risk value of 0.4, a credit card authorization for funds is required in the amount of:

0.975($9000−$7500)=$1,462.50,

which is issued as a credit card authorization against the brokerage account holder's credit card. Upon receiving notification of a successful credit card authorization, the requested funds may be applied to the brokerage account.

It should be noted that the sequence of operations described in conjunction with methods 300 and 400 may be different from that illustrated, respectively, in corresponding FIGS. 3 and 4. For example, the operations at step 404 illustrated in method 400 of FIG. 4 may be executed before the operation of step 402. The steps illustrated in methods 300 and 400 are provided for purposes of illustrating embodiments of the invention and are in no way intended to be limiting in scope.

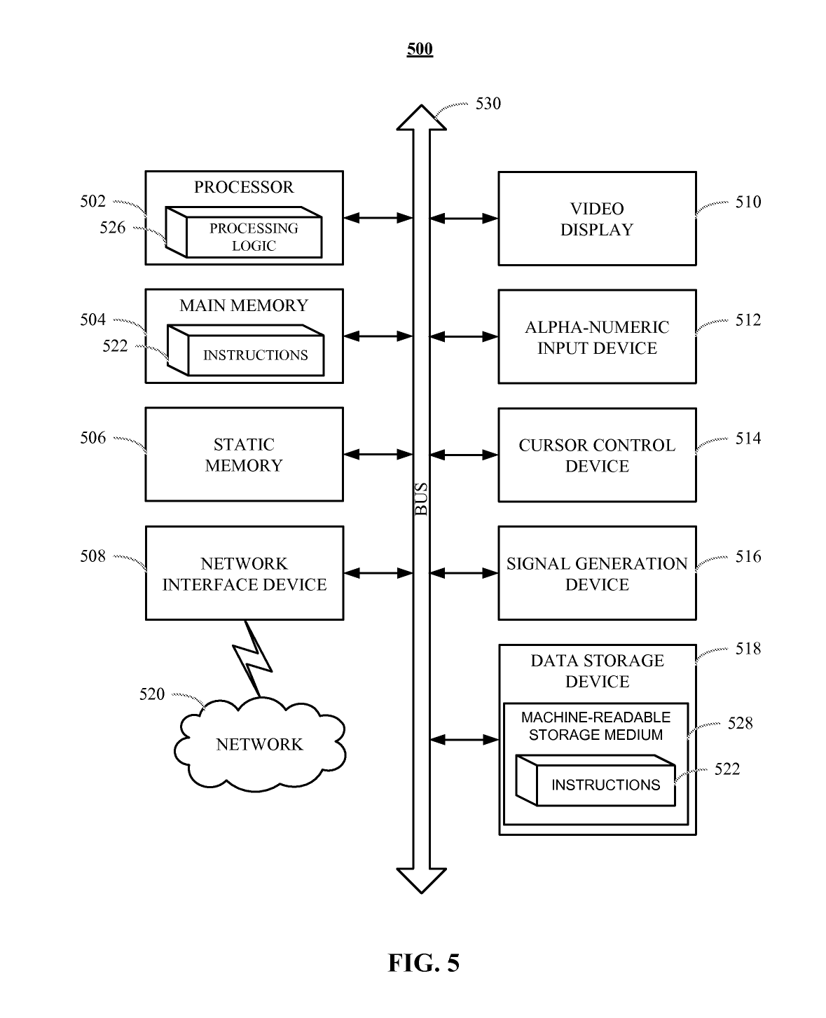

FIG. 5 illustrates a diagrammatic representation of a machine in the exemplary form of a computer system 500 within which a set of instructions, for causing the machine to perform any one or more of the methodologies discussed herein, may be executed. In alternative embodiments, the machine may be connected (e.g., networked) to other machines in a local area network (LAN), an intranet, an extranet, or the Internet. The machine may operate in the capacity of a server or a client machine in a client-server network environment, or as a peer machine in a peer-to-peer (or distributed) network environment. The machine may be a personal computer (PC), a tablet PC, a set-top box (STB), a personal digital assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system 500 may be comprised of a processor 502, a main memory 504 (e.g., read-only memory (ROM), flash memory, dynamic random access memory (DRAM) (such as synchronous DRAM (SDRAM) or Rambus DRAM (RDRAM), etc.), a static memory 506 (e.g., flash memory, static random access memory (SRAM), etc.), and a data storage device 518, which communicate with each other via a bus 530.

Processor 502 represents one or more general-purpose processing devices such as a microprocessor, central processing unit, or the like. More particularly, the processing device may be complex instruction set computing (CISC) microprocessor, reduced instruction set computer (RISC) microprocessor, very long instruction word (VLIW) microprocessor, or processor implementing other instruction sets, or processors implementing a combination of instruction sets. Processor 502 may also be one or more special-purpose processing devices such as an application specific integrated circuit (ASIC), a field programmable gate array (FPGA), a digital signal processor (DSP), network processor, or the like. Processor 502 is configured to execute processing logic 526 for performing the operations and steps discussed herein.

Computer system 500 may further include a network interface device 508. Computer system 500 also may include a video display unit 510 (e.g., a liquid crystal display (LCD) or a cathode ray tube (CRT)), an alphanumeric input device 512 (e.g., a keyboard), a cursor control device 515 (e.g., a mouse), and a signal generation device 516 (e.g., a speaker).

Data storage device 518 may include a machine-readable storage medium (or more specifically a computer-readable storage medium) 528 having one or more sets of instructions (e.g., software 522) embodying any one or more of the methodologies of functions described herein. For example, software 522 may store instructions to conduct a rewards program. Software 522 may also reside, completely or at least partially, within main memory 504 and/or within processor 502 during execution thereof by computer system 500; main memory 504 and processor 502 also constituting machine-readable storage media. Software 522 may further be transmitted or received over a network 520 via network interface device 508.

Machine-readable storage medium 528 may also be used to store instructions to conduct a rewards program. While machine-readable storage medium 528 is shown in an exemplary embodiment to be a single medium, the term “machine-readable storage medium” should be taken to include a single medium or multiple media (e.g., a centralized or distributed database, and/or associated caches and servers) that store the one or more sets of instructions. The term “machine-readable storage medium” shall also be taken to include any medium that is capable of storing or encoding a set of instruction for execution by the machine and that causes the machine to perform any one or more of the methodologies of the present invention. The term “machine-readable storage medium” shall accordingly be taken to include, but not be limited to, solid-state memories, and optical and magnetic media.

Whereas many alterations and modifications of the present invention will no doubt become apparent to a person of ordinary skill in the art after having read the foregoing description, it is to be understood that any particular embodiment described and shown by way of illustration is in no way intended to be considered limiting. Therefore, references to details of various embodiments are not intended to limit the scope of the claims, which in themselves recite only those features regarded as the invention.

What is claimed is:

1. A computer-implemented method, said method comprising:
identifying, using a programmed computer, an actual maintenance requirement for a brokerage account;
establishing, using said programmed computer, a soft maintenance requirement for the brokerage account;
monitoring, using said programmed computer, compliance of said brokerage account against said soft maintenance requirement;
determining, using said programmed computer, said brokerage account is not in compliance with said soft maintenance requirement;
identifying, using said programmed computer, a credit card account associated with said brokerage account; and
requesting, using said programmed computer, a credit card authorization of funds from said credit card account when said brokerage account is not in compliance with said soft maintenance requirement, said requested funds being applied to said brokerage account.

2. The computer-implemented method of claim 1, further comprising:
determining, using said programmed computer, said brokerage account is in compliance with said soft maintenance requirement; and
applying, using said programmed computer, a refund of said requested funds to said credit card account.

3. The computer-implemented method of claim 1, wherein said soft maintenance requirement is a value greater than said actual maintenance requirement.

4. The computer-implemented method of claim 1, wherein said funds requested in said credit card authorization is a monetary amount calculated based on a risk value, said risk value representative of a probability that said brokerage account will not be compliant with said actual maintenance requirement at a future point in time.

5. The computer-implemented method of claim 4, wherein said risk value is determined based on a calculation comprising a current monetary value of said brokerage account, a monetary value representative of said actual maintenance requirement, a monetary value representative of said soft maintenance requirement and a volatility measure.

6. The computer-implemented method of claim 5, wherein said monetary amount of said funds requested in said credit card authorization is determined based on a calculation comprising said risk value, said current monetary value of said brokerage account, and said monetary value representative of said soft maintenance requirement.

7. The computer-implemented method of claim 1, wherein said requested funds being applied to said brokerage account are not made available to the brokerage account in the form of additional buying power.

8. The computer-implemented method of claim 1, wherein said requested funds being applied to said brokerage account is a temporary transfer of funds.

9. A computer system, comprising:
a memory; and
a processing device communicatively coupled to said memory, said processing device configured to:
identify an actual maintenance requirement for a brokerage account;
establish a soft maintenance requirement for the brokerage account;
monitor compliance of said brokerage account against said soft maintenance requirement;
determine said brokerage account is not in compliance with said soft maintenance requirement;
identify a credit card account associated with said brokerage account; and
request a credit card authorization of funds from said credit card account when said brokerage account is not in compliance with said soft maintenance requirement, said requested funds being applied to said brokerage account.

10. A non-transitory computer-readable storage medium programmed to include instructions that, when executed by a processing device, cause the processing device to perform a method, said method comprising:
identifying an actual maintenance requirement for a brokerage account;
establishing a soft maintenance requirement for the brokerage account;
monitoring compliance of said brokerage account against said soft maintenance requirement;
determining said brokerage account is not in compliance with said soft maintenance requirement;
identifying a credit card account associated with said brokerage account; and
requesting a credit card authorization of funds from said credit card account when said brokerage account is not in compliance with said soft maintenance requirement, said requested funds being applied to said brokerage account.
